(19) United States
(12) Patent Application Publication
(10) Pub. No.: US 2010/0034380 A1
(43) Pub. Date: Feb. 11, 2010

(54) SCANNING APPARATUS, HOST APPARATUS AND SCAN IMAGE PROCESSING METHOD THEREOF

(75) Inventor: Hak-ju LEE, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/534,960

(22) Filed: Aug. 4, 2009

(30) Foreign Application Priority Data
Aug. 6, 2008 (KR) 2008-77090

(51) Int. Cl. H04N 1/44; H04L 9/08

(52) U.S. Cl. 380/243; 380/284; 380/46

(57) ABSTRACT

A scanning apparatus, a host apparatus and a scan image processing method thereof. The scan image processing method of the scanning apparatus includes generating a scan image by using a scan target document, obtaining an encryption key which includes color space information, and performing encrypting for the scan image by using the encryption key.

### CROSS-REFERENCE TO RELATED APPLICATIONS

This application claims priority from Korean Patent Application No. 10-2008-0077090, filed on Aug. 6, 2008 in the Korean Intellectual Property Office, the disclosure of which is incorporated herein by reference.

### BACKGROUND

1. Field of the Invention

The present general inventive concept relates to a scanning apparatus, a host apparatus and a scan image processing method thereof, and more particularly, to a scanning apparatus, a host apparatus and a scan image processing method thereof, which can encrypt a scan image.

2. Description of the Related Art

A scanning apparatus such as a scanner, a multifunction device scans an image which is a predetermined scanning target from a document, and generates a scan image. The generated scan image is transmitted to a host apparatus via correcting and encrypting processes.

In detail, an RGB scan image generated in the scanning apparatus is corrected for a smooth color reproduction in the host apparatus, that is, converted to correspond to a standard color space such as an XYZ or an Lab, and the corrected scan image is encrypted for security during being transmitted to the host apparatus through a network.

However, recently, as resolution increases for a quality improvement of the scan image, and accordingly, an amount of data to store or process the scan image increases, a processing speed decreases in performing the above converting and encrypting of the scan image, and accordingly, this method takes much longer time to process the scan image, thereby causing a user inconvenience.

Also, since the conventional scanning apparatus performs the encrypting in a block unit of the scan image, and the encrypting in the block unit is under the premise of readability to some extent, a security effect of data is deteriorated.

### SUMMARY

Accordingly, the present general inventive concept provides a scanning apparatus, a host apparatus and a scan image processing method thereof performing converting and encrypting of a scan image by a single processing to improve a data processing speed, thereby solving a user inconvenience.

The present general inventive concept also provides a scanning apparatus, a host apparatus and a scan image processing method thereof performing encrypting by using a randomly generated encryption key, thereby improving a security effect of data.

Additional aspects and utilities of the present general inventive concept will be set forth in part in the description which follows and, in part, will be obvious from the description, or may be learned by practice of the general inventive concept

An embodiment of the present general inventive concept provides a scan image processing method of a scanning apparatus, including generating a scan image from a target document, obtaining an encryption key which includes a color space information, and performing encrypting for the scan image by using the encryption key.

The performing the encrypting may include converting the scan image to correspond to a color space of the encryption key.

The performing the encrypting may include multiplying each RGB pixel value of the scan image by a predetermined weight which is generated out of the encryption key, and adding the weighted RGB pixel values.

The obtaining the encryption key may include obtaining the encryption key from at least one of a host apparatus and the scanning apparatus.

The obtaining the encryption key may include transmitting the encryption key from the host apparatus to the scanning apparatus if the encryption key is obtained from the host apparatus.

The obtaining the encryption key may include decrypting the obtained encryption key.

The obtaining the encryption key may include generating the encryption key by using a random number.

The encryption key may be encrypted based on an encryption profile.

The scan image processing method may further include: making a host apparatus receive the encrypted scan image from the scanning apparatus, and decrypting the scan image which is received from the scanning apparatus by using the encryption key.

The scan image processing method may further include converting the decrypted scan image to correspond to a color space of the host apparatus.

An embodiment of the present general inventive concept also provides a scanning apparatus which is connectable with a host apparatus, the scanning apparatus including a scanning unit which generates a scan image from a target document, a communicating unit which receives an encryption key which includes a color space information from the host apparatus, and an encrypting unit which performs encrypting for the scan image by using the encryption key.

The encrypting unit may perform the encrypting by converting the scan image to correspond to a color space of the encryption key.

The encrypting unit may perform the encrypting by multiplying each RGB pixel value of the scan image by a predetermined weight which is generated out of the encryption key, and adding the weighted RGB pixel values.

The encrypting unit may decrypt the received encryption key.

The present invention provides a host apparatus which is connectable with a scanning apparatus, the host apparatus including: a key generating unit which generates an encryption key which includes a color space information; and an encrypting unit which decrypts a scan image which is received from the scanning apparatus by using the generated encryption key.

The encryption key may be generated by using a random number.

The host apparatus may further include a storing unit which stores an encryption profile, wherein the encrypting unit encrypts the encryption key based on the encryption profile.

The host apparatus may further include a communicating unit which transmits the encrypted encryption key to the scanning apparatus.

The host apparatus may further include an image processing unit which converts the decrypted scan image to correspond to a color space of the host apparatus.

An embodiment of the present invention general inventive concept also provides An image processing apparatus including a host apparatus to generate an encryption key representing color space information, and a scanning apparatus to generate a scan image from a target document, to receive the encryption key from the host apparatus, and to perform encrypting for the scan image according to the encryption key, wherein the host apparatus may further include an encrypting unit to decrypt data of the encrypted scan image received from the scanning apparatus according to the generated encryption key.

An embodiment of the present invention general inventive concept also provides an image processing apparatus including a scan unit to generate data components of an image, and an encrypting unit to encrypt respective ones of the data components of the image in a predetermined unit according to an encryption key.

The encrypting unit may convert the data components from a color space into another color space, and the encrypting unit encrypts another data components of the anther color space according to the encryption key.

The encryption key may include information on a color apace of the data components of the image.

The scanning unit may include at least one of an element to generate a laser beam to scan a document to generate the scan image and an element to print an image corresponding to the scan image.

An embodiment of the present invention general inventive concept also provides an image processing apparatus including a key generating unit configured to output an encryption key to an external unit, and a unit connected to the external unit and configured to encrypt the encryption key to be output to the external unit, to receive data components of an image encrypted in a predetermined block by the external unit according to the encrypted encryption key, and to decrypt the received encrypted image according to the encryption key.

An embodiment of the present invention general inventive concept also provides an image processing apparatus including a first apparatus configured to generate data components of an image, and to encrypt respective ones of the data components of the image in a predetermined unit according to an encryption key, and a second apparatus connectable to the first apparatus and configured to output the encryption key to the first apparatus, to encrypt the encryption key to be output to the external unit, to receive data components of the image encrypted by the external unit according to the encrypted encryption key, and to decrypt the received encrypted image according to the encryption key.

An embodiment of the present invention general inventive concept also provides a computer-readable medium to contain computer-readable medium as a program to perform a method of an image processing method of a scanning apparatus, the method including generating a scan image from a target document, obtaining an encryption key which comprises color space information, and performing encrypting for the scan image by using the encryption key.

### BRIEF DESCRIPTION OF THE DRAWINGS

The present general inventive concept will become apparent and more readily appreciated from the following description of the exemplary embodiments, taken in conjunction with the accompanying drawings, in which:

FIG. 1 is a block diagram illustrating a configuration of a scanning system according to an exemplary embodiment of the present general inventive concept;

FIG. 2 schematically illustrates a converting process of a scan image according to the exemplary embodiment of the present general inventive concept;

FIG. 3 illustrates an example of an encryption profile stored in a storing unit;

FIG. 4 is a flowchart illustrating a scan image processing method according to an exemplary embodiment of the present general inventive concept;

FIG. 5 is a figure for describing the scan image processing method according to the exemplary embodiment of the present general inventive concept;

FIG. 6 is a figure for describing an encrypting process of a scan image according to the exemplary embodiment of the present general inventive concept; and

FIG. 7 is a figure for describing decrypting and image processing processes of a scan image according to the exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present general inventive concept by referring to the figures. Repetitive description with respect to like elements of different embodiments may be omitted for the convenience of clarity.

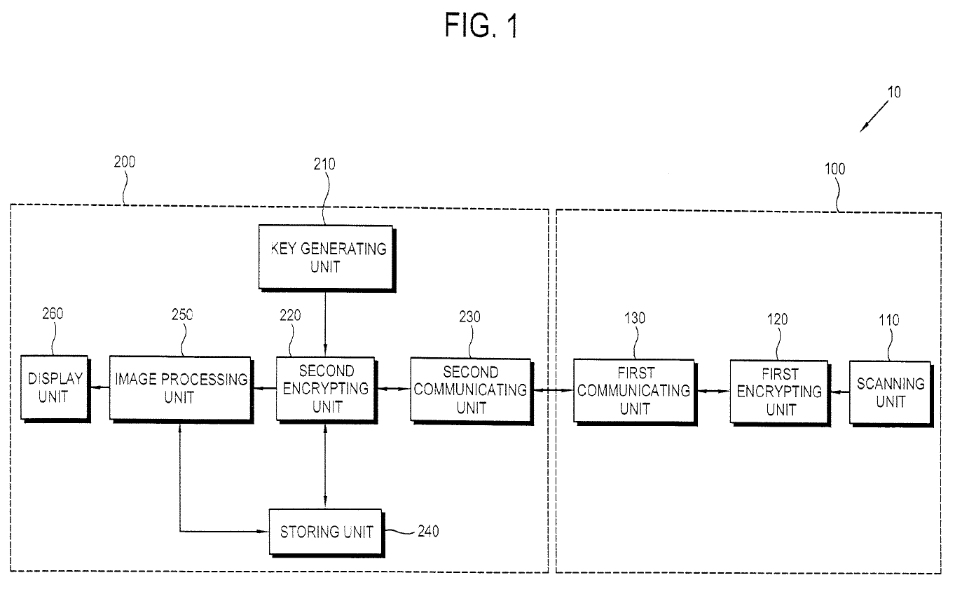

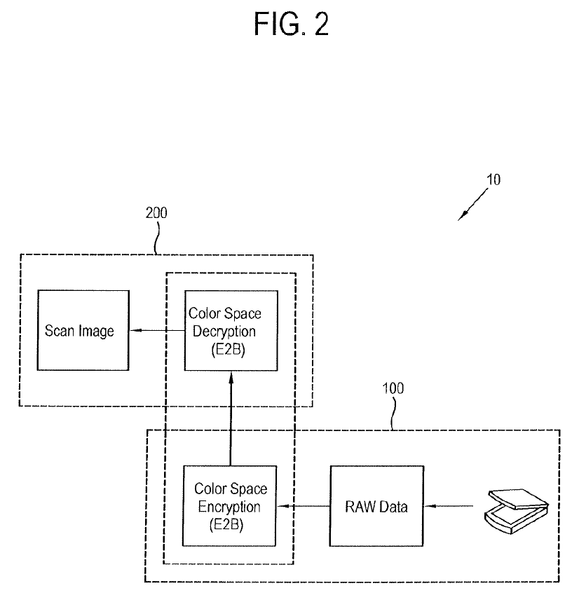

FIG. 1 is a block diagram illustrating a configuration of a scanning system 10 according to an exemplary embodiment of the present general inventive concept, and FIG. 2 is a schematic diagram illustrating a converting process of a scan image according to the exemplary embodiment of the present general inventive concept.

The scanning system 10 according to the present exemplary embodiment includes a scanning apparatus 100 and a host apparatus 200. The scanning apparatus 100 is implemented as a scanner, a multifunction device performing more than two functions, etc., and is connected with the host apparatus 200 implemented as a personal computer (PC), etc.

As illustrated in FIG. 2, the scanning apparatus 100 according to the present exemplary embodiment scans an image from a document to generate a scan image, and encrypts and transmits the generated scan image to the host apparatus 200 through a network, etc.

According to the present general inventive concept, the scanning apparatus 100 may be an image forming apparatus or a facsimile apparatus. In this case, the scanning apparatus 100 may include a wired or wireless communication unit to communicate with another scanning apparatus to receive an image or a scan image, or include elements as a printing unit to feed a printing medium, to print an image on the printing medium according to data of the received image or scan image, and to discharge the printing medium.

As illustrated in FIG. 1, the scanning apparatus 100 includes a scanning unit 110, a first encrypting unit 120 and a first communicating unit 130.

The scanning unit 110 scans a target document to generate a scan image. The target document includes a document, a photograph, a film, etc. Here, the scanning unit 110 may scan the target document in a predetermined block unit to generate a scan image, and the generated scan image may be raw data, for example, RGB raw data.

The predetermined block unit may be a unit of a line or lines, or may be a unit of a page depending on a user preference or automatically set preference. For example, respective ones of R components, G components, and B components (data components or color data components) of the scan image can be separately encrypted in a predetermined block unit, compared to a conventional encryption of encrypting the scan image in a conventional block unit.

The scanning unit 110 may have one or more elements to generate or scan light or laser beam toward the target document and one or more elements to receive the light or laser beam reflected from the target document to generate the scan image.

The first encrypting unit 120 decrypts an encryption key received through the first communicating unit 130 by a predetermined encryption algorithm, and performs encrypting for the scan image by using the decrypted encryption key. Here, the encrypting for the scan image is converting the scan image to correspond to a color space of the encryption key. The first encrypting unit 120 may be implemented as a firmware, a software, etc. The encrypting unit 120 may be a control unit to control elements of the scanning apparatus 1000 and to encrypt and/or decrypt data of the scan image and/or data encryption key, respectively.

The first communicating unit 130 performs a communication with the host apparatus 200. In detail, the first communicating unit 130 receives an encryption key having color space information from the host apparatus 200, and transmits a scan image encrypted by the received encryption key to the host apparatus 200. The first communicating unit 130 may be implemented as wire or wireless communication modules capable of communicating with an external device such as the host apparatus 200.

As illustrated in FIG. 1, the host apparatus 200 includes a key generating unit 210, a second encrypting unit 220, a second communicating unit 230, a storing unit 240, an image processing unit 250 and a display unit 260. The second encrypting unit 220, the second communicating unit 230, and the image processing unit 250 may be referred to as a control unit to encrypt or decrypt data of a received image or key, to process the encrypted or decrypted data, and to communicate with an external device to transmit and receive data of an image and/or a key relating the image.

The key generating unit 210 generates an encryption key (hereinafter, also referred to as ‘E-KEY’) having color space information. Here, the generated encryption key may be randomly generated, that is, generated by using a random number.

The second encrypting unit 220 performs encrypting for the generated encryption key. Here, the second encrypting unit 220 may perform the encrypting for the encryption key based on an encryption profile 20 stored in the storing unit 240. Here, the encrypting may be performed by an asymmetric encryption such as a Rivest Shamir Adleman (RSA).

Also, the second encrypting unit 220 decrypts a scan image received from and/or encrypted in the scanning apparatus 100 according to the encryption key generated in the key generating unit 210. The key generating unit 210 and the second encrypting unit 220 may be implemented as a firmware, a software, etc., and may be implemented as a single configuration according to the present general inventive concept.

The second communicating unit 230 transmits an encrypted encryption key to the scanning apparatus 100, and receives a scan image from the scanning apparatus 100. The second communicating unit 230 may be implemented as wire or wireless communication modules capable of communicating with the scanning apparatus 100.

The storing unit 240 stores the encryption profile 20 for encrypting a generated encryption key, and converting a received scan image.

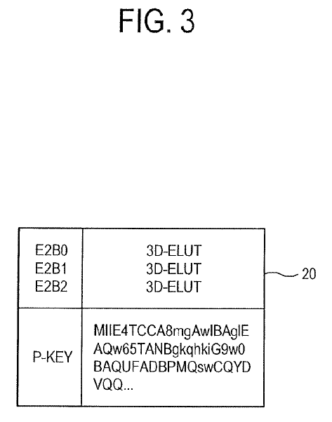

FIG. 3 illustrates an example of the encryption profile 20 stored in the storing unit 240.

As illustrated in FIG. 3, the encryption profile 20 includes information about a lookup table (LUT) (hereinafter, also referred to ‘E2B ELUT’) for processing a scan image, and a public key (hereinafter, also referred to ‘P-KEY’) for performing encrypting for a randomly generated encryption key.

Also, an encryption key generated in the second encrypting unit 220 is stored in the storing unit 240, and a scan image (or encrypted scan image) received from the scanning apparatus 100 may be stored in the storing unit 240.

The storing unit 240 may be implemented as internal or external type storing modules such as a hard disk drive (HDD), a flash memory, etc.

The image processing unit 250 processes a scan image decrypted in the second encrypting unit 220 to enable a smooth color reproduction in the host apparatus 200. In detail, if a scan image received from the scanning apparatus 100 is decrypted in the second encrypting unit 220, the image processing unit 250 processes the decrypted scan image by referring to a lookup table stored in the storing unit 240 so that the scan image can be displayed in the host apparatus 200.

The lookup table may be a table usable to convert data of a first color space into data of a second color space suitable to display an image of the data on a display unit or to print an image of the data in a printing unit.

Here, the processed scan image may be implemented as PCS data corresponding to a standard color space such as an RGB color space defined by R, G, and B color components, an XYZ color space defined by X, Y, Z components, and a Lab color space defined by L, a, and b components. If the scan image is processed as the PCS data, the image processing unit 250 may convert this into an R‘G’B data to be appropriate to a color reproduction property of the host apparatus 200 one more.

The display unit 260 displays a scan image processed in the image processing unit 250. The display unit 260 may include a thin film transistor liquid crystal display (TFT-LCD) and a driving unit (not illustrated) driving the TFT-LCD. The display unit 260 may display an image representing information on the scan image, the encrypted image, the decrypted image and/or the key relating to the encryption and decryption.

Although a scan image is used in this embodiment, the scan image may be an image stored in a memory device of the scanning apparatus 100, or may be an image transmitted from an external apparatus. Therefore, the scan image can be referred to as data or image scanned, stored, or received in the scanning system 10.

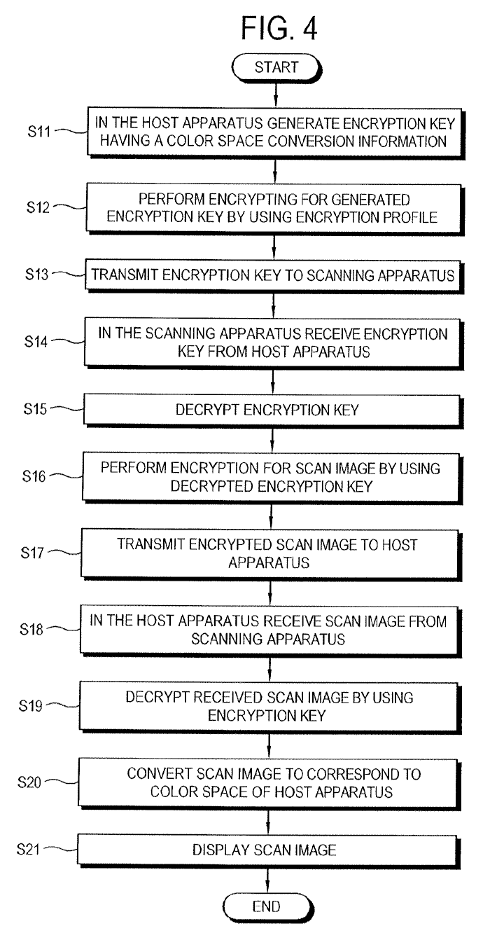

Hereinafter, a scan image processing process in the scanning system 10 including the scanning apparatus 100 and the host apparatus 200 according to the above configuration will be described by referring to FIGS. 4 to 6.

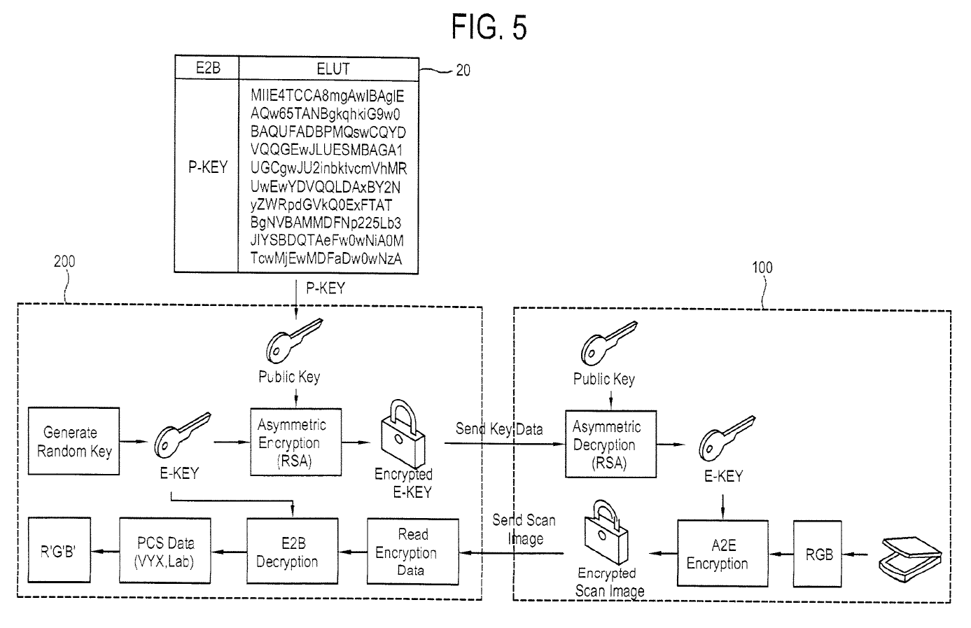

Referring to FIGS. 4 and 5, the key generating unit 210 of the host apparatus 200 randomly generates an encryption key (E-KEY) having a color space conversion information (S11).

Then, the second encrypting unit 220 performs encrypting for the encryption key (E-KEY) generated in the operation S11 by using the encryption profile stored in the storing unit 240 in operation S12. Here, the second encrypting unit 220 performs the encrypting for the encryption key (E-KEY) by an asymmetric encryption such as the RSA by using a public key (P-KEY) of the encryption profile 20.

The encryption key (encrypted E-KEY) encrypted in the operation S12 is transmitted to the scanning apparatus 100 through the second communicating unit 230 in operation S13.

The scanning apparatus 100 receives the encrypted encryption key (encrypted E-KEY) from the host apparatus 200 through the first communicating unit 130 in operation S14.

The first encrypting unit 120 performs operation S15 of decrypting for the encrypted encryption key (encrypted E-KEY) received in the operation S14. Here, the first encrypting unit 120 may perform the decrypting by an asymmetric encryption such as the RSA by using a private key corresponding to the public key (P-KEY) used in the encrypting.

If an RGB scan image is generated through the scanning unit 110, the first encrypting unit 120 of the scanning apparatus 100 performs operation S16 of an encrypting for the scan image by using the encryption key (E-KEY) decrypted in the operation S15.

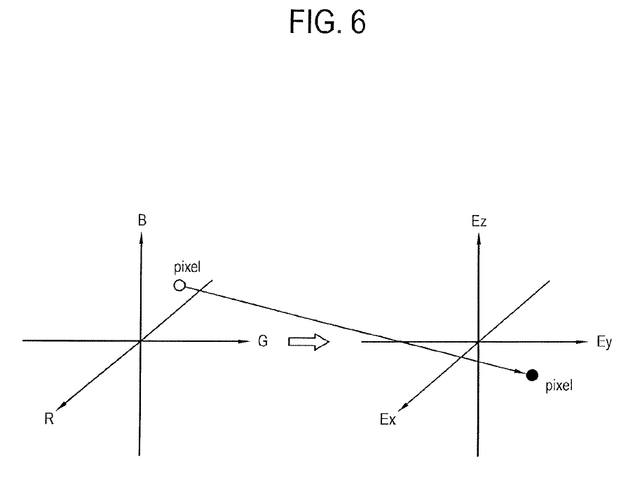

FIG. 6 is a figure illustrating an encrypting process of a scan image according to the exemplary embodiment of the present general inventive concept.

As illustrated in FIG. 6, the encrypting in the operation S16 is a process of converting a scan image to correspond to a color space of an encryption key (E-KEY) by using a color space information. In the present invention, the converting process for the scan image is also referred to ‘A2E conversion’ and/or‘A2E encryption.’

In detail, the first encrypting unit 120 generates each weight of x, y and z factors corresponding to a converted color space by using a decrypted encryption key. In the present exemplary embodiment, the weight of the x factor is Ax, Bx and Cx, the weight of the y factor is Ay, By and Cy, and the weight of the z factor is Az, Bz and Cz. The first encrypting unit 120 respectively multiplies each pixel of RGB of the scan image by each weight generated, and adds these, thereby converting to correspond to the color space of the encryption key like the following equations.

Ex=Ax×R+Bx×G+Cx×B

Ey=Ay×R+By×G+Cy×B

Ez=Az×R+Bz'G+Cz×B Equation 1

Accordingly, scan data of an RGB color space is converted to correspond to color spaces Ex, Ey and Ez, that is, the color space of the encryption key. Here, the encryption key is data that is randomly generated in the operation S11, and since the operation S16 performs the encrypting by a random encryption key, a security effect is improved in comparison to the conventional encrypting in a block unit. Also, since the operation S16 concurrently performs the encrypting and the color space converting, a processing speed is improved in comparison to the conventional case in which two operations of the color space converting and the encrypting are performed.

The RGB data of the scan image may include R data of pixels of the scan image, G data of the pixels of the scan image, and B data of the pixels of the scan image which represent values of pixels of the scan image in the RGB color space defined by R, G, and B components. The RGB data can be converted into X data, Y data, and Z data of the corresponding pixels in the color space defined by X, Y, Z components. The RGB components (RGB data) or XYZ components (XYZ data) may be referred to as data components of the scan image.

The scan image may include one or more predetermined block units, one or more lines, or a page unit in the RGB data, that is, R, G, and B color components or converted color components. The respective color components of the scan image in a unit according to a user preference or an automatically set preference can be encrypted according to the present general inventive concept.

Then, the scanning apparatus 100 transmits the scan image (data of the converted scan image) encrypted by the encryption key to the host apparatus 200 through the first communicating unit 130 in operation S17.

The host apparatus 200 receives the encrypted scan image through the second communicating unit 230 in operation S18.

In operation S19, the second encrypting unit 220 decrypts the scan image received in the operation S18 by using the encryption key generated in the operation S11.

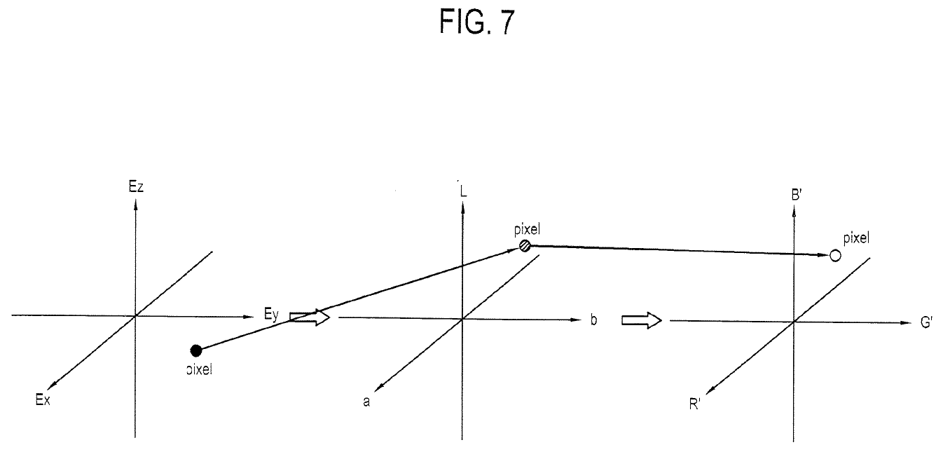

FIG. 7 is a figure illustrating decrypting and image processing processes of a scan image according to the exemplary embodiment of the present general inventive concept.

As illustrated in FIG. 7, the decrypting in the operation S19 is a process of converting a scan image to correspond to a color space which is reproducible in the host apparatus 200 by using a color space information of an encryption key (E-KEY). In the present invention, the converting process for the scan image is also referred to ‘E2B conversion’ and/or ‘E2B encryption.’

For example, referring to FIG. 7, the second encrypting unit 220 may convert a scan image in the color space defined by Ex, Ey, and Ez, to correspond to a Lab color space defined by L, a, and b, according to an encryption key and a lookup table (E2B ELUT) of the encryption profile 20. Here, the scan image may be converted to correspond to xyz defined by s, y, and z, or RGB color spaces defined by R′, G′, and B′, in addition to the lab depending on information of the lookup table.

The image processing unit 250 may convert the scan image decrypted in the operation S19 to further excellently reflect a color reproduction property in the host apparatus 200 in operation S20. For example, referring to FIG. 7, the scan image converted to correspond to the Lab color space may be converted to a data of an R′G′B′ color space to correspond to the display unit 260 of the host apparatus 200.

The scan data converted in the operation S20 is displayed in the display unit 260 in operation S21.

In the present exemplary embodiment, it is described that the encryption key (E-KEY) is generated in the host apparatus 200, and the scanning apparatus 100 receives this to perform the encrypting for the scan image. Alternatively, the encryption key (E-KEY) may be generated in the scanning apparatus 100 to be transmitted to the host apparatus 200, or may be generated by a separate process to be supplied to the scanning apparatus 100 and the host apparatus 200.

Also, the RSA is exemplarily described with respect to the encrypting and the decrypting for the encryption key (E-KEY). Alternatively, various encryption algorithms may be applied thereto.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertain.

As described above, a scanning apparatus, a host apparatus and a scan image processing method thereof according to the present invention performs converting and encrypting of a scan image by a single processing to improve a data processing speed, thereby solving a user inconvenience.

Also, since encrypting is performed by using a randomly generated encryption key, a security effect of data may be improved.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A scan image processing method of a scanning apparatus, comprising:
generating a scan image from a target document;
obtaining an encryption key which comprises color space information; and
performing encrypting for the scan image by using the encryption key,
wherein the obtaining the encryption key comprises obtaining the encryption key from at least one of a host apparatus and the scanning apparatus.

2. The scan image processing method according to claim 1, wherein the performing the encrypting comprises converting the scan image to correspond to a color space of the encryption key.

3. The scan image processing method according to claim 1, wherein the performing the encrypting comprises multiplying each RGB pixel value of the scan image by a predetermined weight which is generated out of the encryption key, and adding the weighted RGB pixel values.

4. The scan image processing method according to claim 1, wherein the obtaining the encryption key comprises transmitting the encryption key from the host apparatus to the scanning apparatus if the encryption key is obtained from the host apparatus.

5. The scan image processing method according to claim 1, wherein the obtaining the encryption key comprises decrypting the obtained encryption key.

6. The scan image processing method according to claim 1, wherein the obtaining the encryption key comprises generating the encryption key by using a random number.

7. The scan image processing method according to claim 6, wherein the encryption key is encrypted based on an encryption profile.

8. The scan image processing method according to claim 1, further comprising:
making a host apparatus receive the encrypted scan image from the scanning apparatus, and decrypting the scan image which is received from the scanning apparatus by using the encryption key.

9. The scan image processing method according to claim 8, further comprising converting the decrypted scan image to correspond to a color space of the host apparatus.

10. A scanning apparatus which is connectable with a host apparatus, the scanning apparatus comprising:
a scanning unit which generates a scan image from a target document;
a communicating unit which receives an encryption key which comprises a color space information from the host apparatus; and
an encrypting unit which performs encrypting for the scan image by using the encryption key.

11. The scanning apparatus according to claim 10, wherein the encrypting unit performs the encrypting by converting the scan image to correspond to a color space of the encryption key.

12. The scanning apparatus according to claim 10, wherein the encrypting unit performs the encrypting by multiplying each RGB pixel value of the scan image by a predetermined weight which is generated out of the encryption key, and adding the weighted RGB pixel values.

13. The scanning apparatus according to claim 10, wherein the encrypting unit decrypts the received encryption key.

14. A host apparatus which is connectable with a scanning apparatus, the host apparatus comprising:
a key generating unit which generates an encryption key which comprises color space information;
an encrypting unit which decrypts a scan image which is received from the scanning apparatus by using the generated encryption key; and
a storing unit which stores an encryption profile,
wherein the encrypting unit encrypts the encryption key based on the encryption profile.

15. The host apparatus according to claim 14, wherein the encryption key is generated by using a random number.

16. The host apparatus according to claim 14, further comprising:
a communicating unit which transmits the encrypted encryption key to the scanning apparatus.

17. The host apparatus according to claim 14, further comprising:
an image processing unit which converts the decrypted scan image to correspond to a color space of the host apparatus.

18. An image processing apparatus comprising:
a host apparatus to generate an encryption key representing color space information; and
a scanning apparatus to generate a scan image from a target document, to receive the encryption key from the host apparatus, and to perform encrypting for the scan image according to the encryption key,
wherein the host apparatus further includes an encrypting unit to decrypt data of the encrypted scan image received from the scanning apparatus according to the generated encryption key.

19. An image processing apparatus comprising:
a scan unit to generate data components of an image; and
an encrypting unit to encrypt respective ones of the data components of the image in a predetermined unit according to an encryption key including color space information,
wherein the encrypting unit converts the data components from a color space into another color space, and the encrypting unit encrypts another data components of the anther color space according to the encryption key.

20. An image processing apparatus comprising:
a first apparatus configured to generate data components of an image, and to encrypt respective ones of the data components of the image in a predetermined unit according to an encryption key including space color information; and
a second apparatus connectable to the first apparatus and configured to output the encryption key to the first apparatus, to encrypt the encryption key to be output to the external unit, to receive data components of the image encrypted by the external unit according to the encrypted encryption key, and to decrypt the received encrypted image according to the encryption key.
